(19) United States
(12) Patent Application Publication
(10) Pub. No.: US 2023/0129901 A1
(43) Pub. Date: Apr. 27, 2023

(54) EXCESS COATING REMOVAL DEVICE FOR CAN COATING MACHINES

(71) Applicant: Michael Shelton, Lockport, IL (US)

(72) Inventor: Michael Shelton, Lockport, IL (US)

(73) Assignee: Gerhard Designing & Manufacturing Inc., Bridgeview, IL (US)

(21) Appl. No.: 17/506,875

(22) Filed: Oct. 21, 2021

(51) Int. Cl. B05C 11/10; B05C 1/02

(52) U.S. Cl. CPC B05C 11/1039; B05C 1/022; B05C 1/027

(57) ABSTRACT

An excess coating removal device, which may be used with or retrofit to a can coating machine. Excess coating is removed before it can contact undesirable locations on the machine or the can.

### BACKGROUND OF THE INVENTION

The present invention generally relates to can coating machines and, more specifically, to a device for providing controlled metering of the coating to beer and beverage cans.

Beer and beverage can coating machines are known. These machines apply a liquid UV-curable coating to the bottom rim of the can, to improve the mobility of the can (i.e., decrease its rim friction, so that it slides more easily). The coating may include substances, such as waxes, to enhance mobility, as well as photo initiators that are cured in the presence of UV light. The machines are available in different widths to accommodate various production speeds, and apply the coating in mass so that wider systems coat more cans simultaneously. Machines are also available to coat other types of cans, such as aerosol, aluminum bottles (e.g., prior to neck being inserted onto can), and other cans.

As background, the coating to be applied to the bottom rim of the can may have a weight of about 2-6 milligrams, and may form a coating ring that is about 1 mm wide, and a few micrometers in thickness.

Referring to FIGS. 1-2 and 4-5, a conventional can coating machine is shown, indicated by reference numeral 10. The arrow in FIG. 1 shows the direction of can flow on a conveyor belt. Conventional can coating machine 10 includes three rollers 20, 30 and 40, as shown in FIG. 2, rigidly mounted to frame 80 (shown in FIG. 1 but not in FIG. 2). The amount of coating material applied to the can is controlled by the gap between two offset rolls, an adjustable “metering” roll 20 and a stationary “distribution” roll 30. In FIG. 2, arrows show that metering roll 20 is rotating clockwise, while distribution roll 30 is rotating counterclockwise. An operator wishing to apply a heavy amount of coating to the can opens the metering roll gap further, allowing more coating to transfer to the rubber.

Both rolls 20, 30 may be made of a hard material which wears well, such as chrome. As is well known, metering roll 20 may be adjusted via hand wheel, and a fine pitch (e.g., 20-pitch) screw turned by a gear box (e.g., 20:1, 40:1 or 60:1 gear box), providing a very fine adjustment (e.g., about 0.002″ per revolution). Distribution roll 30 transfers the coating material to rubber “applicator” roll 40.

Cans 50 are transported by conveyor belt 60, dome up (bottom up) beneath applicator roll 40. The coating is inserted at the gap, and as applicator roll revolves (in a clockwise direction) a film of the coating is applied from applicator roll 40 to can rim 50a, and the coated can is then further conveyed under UV lamps (not shown, and located beneath light shield 75, providing UV energy) to cure the coating. Coating machine 10 and UV lamps and light shield 75 are mounted to an adjustable frame 80 (shown in FIGS. 1, 5).

Referring to FIGS. 1 and 5, turning handwheel 85 adjusts the frame height (including the height of the light shield and the applicator coater) for different can height sizes (the conveyor height remains stationary). Referring now to FIG. 3: handwheel 91 adjusts the height of metering roll 20 to adjust the metering roll gap; handwheel 93 is a fine-tuning adjustment for the coater height; and handwheel 94 adjusts the applicator roll gap.

Referring to FIG. 5, machine control panel cooling ducts 70 include exhaust and intake locations 76, 77, respectively, which provide cooling air that flows past the UV lamps, above the cans. Day tank metering pumps 140a provides metered amounts of coating from day tank 140 to applicator roll 40. Can coating machine 10 also includes cooling blower 87, allowing cooling air to be sucked in and flow through duct 81 and through machine components within machine control panel 86.

A problem with current can coating machines is that the operator can apply either too much coating, or too little coating, either of which can cause problems as now described. If the operator sets the control gap between the metering and distribution rolls to be too large, this can transfer too much coating to the applicator roll. When the machine stops, gravity can cause the excess coating to move to the bottom of the applicator roll, where it can drip down under the influence of gravity, faster than the application roll is rotating, and onto the conveyor or onto portions of the can where it is undesirable to have the coating. (Conveyor belts for can machines can be expensive, and if the coating cures on the belt, the belt can crack during use and may need to be replaced. If the coating cures on a portion of the can where ink is to be placed, the can may not accept ink for the label and may need to be scrapped.) Conversely, if the operator applies too much pressure to the rubber applicator roll, it will squeeze the coating off the roll, causing a coating bead to form below the distribution roll. This can also eventually cause dripping on the cans and the conveyor belt.

Accordingly, there is a need for a can coating machine that removes excess coating during operation of the machine, while avoiding excess coating drippage caused by operator actions. Preferably, the excess coating removal device of the present invention can be economically retrofit to existing can coating machines.

### SUMMARY OF THE INVENTION

The objects mentioned above, as well as other objects, are solved by the present invention, which overcomes disadvantages of prior can coating machines, while providing new advantages not previously associated with them. This summary is provided to introduce a selection of concepts in a simplified form that are further described below in the Detailed Description, so that the claimed invention may be better understood. However, this summary is not intended to limit the scope of the claimed subject matter.

In one preferred embodiment of the invention, a machine is provided for coating a portion of a can, while preventing excess coating from dripping onto a conveyor or portions of the can not desired to be coated. The can may be a beer or beverage can, an aerosol can, or other types of cans. The machine includes an application device for applying the coating to the can, such as a bottom rim of the can. A conveyor may be used moving the cans in a controlled fashion adjacent to the application device. An excess coating removal device works in conjunction with the application device, to substantially remove excess coating not needed to coat the can, while substantially preventing the coating from contacting other portions of the can or the conveyor.

In another preferred embodiment, the application device includes an adjustable metering roll and a stationary distribution roll, and the metering and distribution rolls are mounted a predetermined distance from each other, forming an adjustable gap, and the amount of coating applied is controlled by the gap. The gap may be adjusted by turning a handwheel on a gearbox located adjacent the application device, enabling the amount of the coating applied to the can to be selectively increased or decreased. The application device may also include an adjustable applicator roll for applying the coating to the cans, which receives the coating from the distribution roll. The metering roll may have a chrome outer surface, and the distribution roll may have a rubber outer surface.

In yet another preferred embodiment, the excess coating removal device includes a blade, such as a soft rubber (e.g., EPDM) blade, which contacts/wipes against the applicator roll to remove excess coating after the applicator roll has applied the coating to the can. A drip pan may be mounted below the excess coating removal device for catching excess coating removed by the blade. A coating supply tank may be provided in fluid communication with the drip pan.

In an alternative preferred embodiment of the invention, a method is provided for coating a portion of cans, such as beverage or beer cans, while preventing excess coating from dripping onto a conveyor or portions of the can not desired to be coated. An application device applies the coating to the can, such as to the bottom rim of the can, as a conveyor moves the cans in a controlled fashion adjacent to the application device. An excess coating removal device, such as a blade contacting the applicator roll, is providing, working in tandem with the application device, to substantially remove excess coating not needed to coat the selected portion(s) of the can, while substantially preventing the coating from contacting other portions of the can not desired to be coated, or from contacting the conveyor. The removal device may remove the coating from the applicator roll after the applicator roll has applied the coating to the can. An adjustable metering roll may be mounted a predetermined distance from a stationary distribution roll to form a gap, so that the amount of coating applied is controlled by the gap. The gap may be adjusted to adjust the amount of the coating that is applied. Excess coating may be allowed to drip from the blade/removal device to a drip pan mounted below the excess coating removal device. The drip pay may be provided to be in fluid communication with a coating supply tank.

In still another alternative preferred embodiment of the invention, an excess coating removal device is provided for use with a machine for coating a selected portion of a can, while preventing excess coating from dripping onto a conveyor or portions of the can not desired to be coated. The can coating machine may include an application device with an applicator roll for applying the coating to the can, and a conveyor for moving cans in a controlled fashion adjacent to the application device. The application device may include an adjustable metering roll which receives the coating from a stationary distribution roll, and these rolls may be mounted a predetermined distance from each other, forming an adjustable, predetermined gap, such that the amount of coating applied is controlled by this gap.

The excess coating removal device may be provided with, or retrofit to, the machine. The excess coating removal device may include a blade contacting (e.g., wiping against) the applicator roll to substantially remove excess coating not needed to coat the selected portion of the can, to substantially prevent the coating from contacting portions of the can not desired to be coated, or from contacting the conveyor. The blade may include a hard rubber material that is substantially chemically impervious to the coating. The machine may be specifically designed and configured to coat the bottom rim of beer and beverage cans, but other portions of the can may be coated if desired, and other types of cans may be coated, as well.

### Definition of Claim Terms

The terms used in the claims of the patent are intended to have their broadest meaning consistent with the requirements of law. Where alternative meanings are possible, the broadest meaning is intended. All words used in the claims are intended to be used in the normal, customary usage of grammar and the English language.

### BRIEF DESCRIPTION OF THE DRAWINGS

The novel features which are characteristic of the invention are set forth in the appended claims. The invention itself, however, together with further objects and attendant advantages thereof, can be better understood by reference to the following description taken in connection with the accompanying drawings, in which:

FIG. 1 is a planar perspective view of a conventional can coating machine;

FIG. 2 is an enlarged, partial planar perspective view of the conventional rollers used to coat the bottom rim of cans;

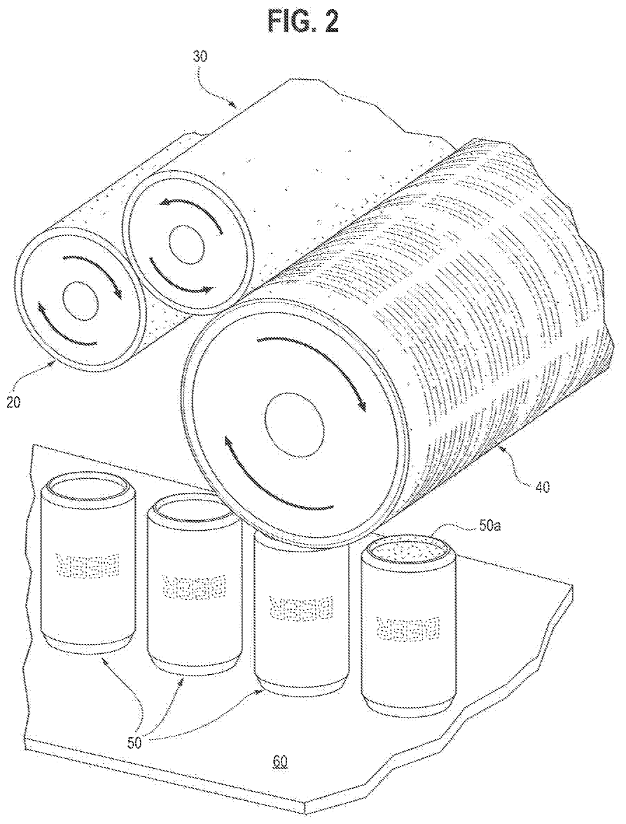

FIG. 3 is a section view of one preferred embodiment of the excess coating removal device of the present invention;

FIG. 4 is an exploded view of the circled portion of FIG. 3, showing the excess coating removal device; and

FIG. 5 is a side view of the conventional can coating machine shown in FIG. 1.

The components in the drawings are not necessarily to scale, as emphasis is instead placed upon clearly illustrating the principles of the present invention. In the drawings, like reference numerals designate corresponding parts throughout the several views.

### DETAILED DESCRIPTION OF THE PREFERRED EMBODIMENTS

Set forth below is a description of what are believed to be the preferred embodiments and/or best examples of the invention claimed. Future and present alternatives and modifications to this preferred embodiment are contemplated. Any alternatives or modifications which make insubstantial changes in function, in purpose, in structure, or in result are intended to be covered by the claims of this patent.

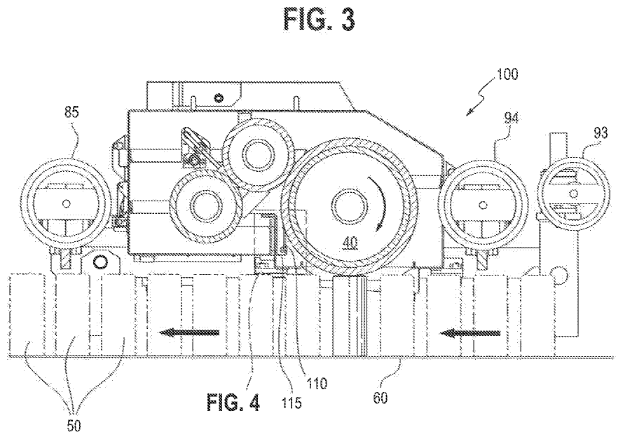

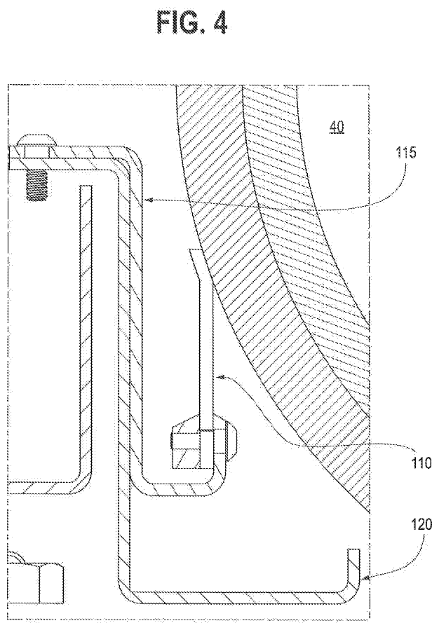

Referring now to FIGS. 3 and 4, the current invention includes an excess coating removal device, designed to work with, and which can be retrofitted to, can coating machine 10 as described above (or another can coating machine). The arrows in FIG. 3 show the direction of can flow.

In a preferred embodiment, excess coating removal device 100 includes a rubber blade 110, mounted to rubber blade mounting bracket 115. Preferably, both rubber applicator roll 40 and rubber blade 110 may be made from a rubber material that is chemically impervious to the coating, such as EPDM (ethylene propylene diene monomer) rubber. Alternatively, the blade could also be made of Teflon or other materials. Preferably blade 110 and its mounting bracket 115, and the associated drip pan 120 positioned below blade 110 (FIG. 6), can be retrofit to can coating machine 10, making the machine more user friendly by minimizing problems caused by operator error resulting in under-coating or over-coating.

In the preferred embodiment, rubber blade 110 removes excess coating not needed to be applied to the can rim, in a controlled manner. Rubber blade 110 may be set at a predetermined distance from applicator roll 40, equal to the desired coating thickness. The blade removes the coating from the applicator roll after a can has been coated and before more coating is transferred, keeping the coating from building on the applicator roll, which can lead to the dripping.

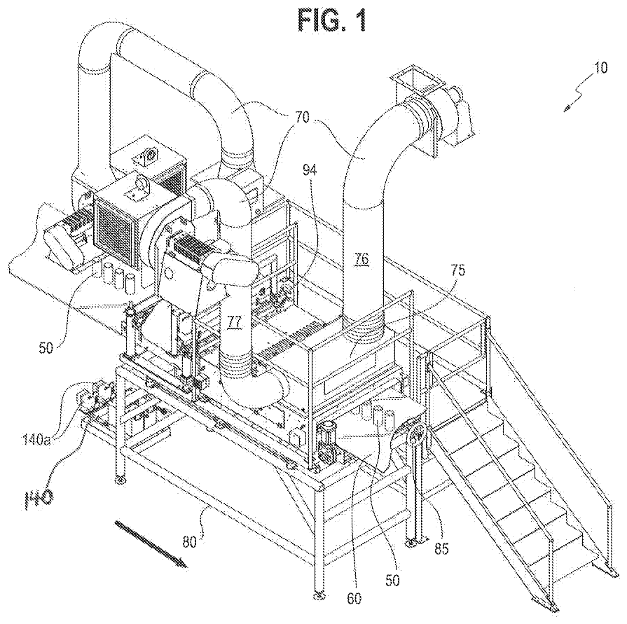

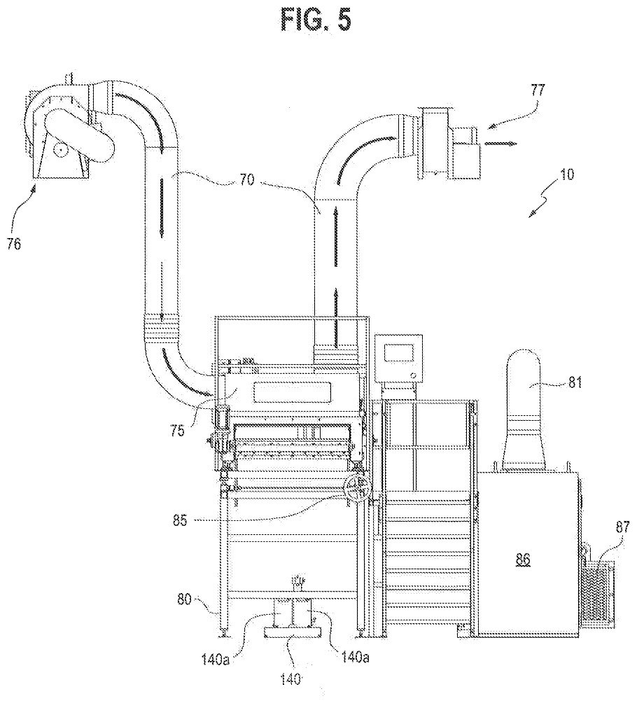

Blade mounting bracket 115 may be mounted to drip pan 120. Excess coating is removed by rubber blade 110 as applicator roll 40 revolves. This excess coating is scraped by blade 110 and allowed to drip from blade 110 into drip pan 120. From drip pan 120, the excess coating may be returned to day tank (coating supply tank, see FIGS. 1, 5) 140, for further use. The blade will also catch drips caused by too much pressure on the rubber applicator roll. Again, the blade scrapes roll 40 and removes excess coating, which is then returned to the day tank for further use.

In another embodiment of the invention, instead of the rubber blade shown, a gravure roller could be used (roll with grooves that runs in a coating bath), utilizing a doctor blade to control the coating thickness. A problem with this design is that in order to change coating weight applied to the can, a new roll with different grooves would be required to be used.

The above description is not intended to limit the meaning of the words used in the following claims that define the invention. Persons of ordinary skill in the art will understand that a variety of other designs still falling within the scope of the following claims may be envisioned

I claim:

1. A machine for coating a selected portion of a can, while preventing excess coating from dripping onto a conveyor or portions of the can not desired to be coated, comprising:
an application device for applying the coating to the can;
a conveyor for moving cans in a controlled fashion adjacent to the application device; and
an excess coating removal device working with the application device, for substantially removing excess coating not needed to coat the selected portion of the can, while substantially preventing the coating from contacting other portions of the can or the conveyor.

2. The machine of claim 1, wherein the machine is designed and configured to coat a bottom rim of beer and beverage cans.

3. The machine of claim 1, wherein the application device comprises an adjustable metering roll and a stationary distribution roll, and the metering and distribution rolls are adjustably mounted a predetermined distance from each other, forming an adjustable gap, and wherein the amount of coating applied to the can is controlled by the gap.

4. The machine of claim 3, wherein the gap is adjustable by turning a handwheel on a gearbox located adjacent the application device, thereby enabling the amount of the coating applied to the can to be selectively increased or decreased.

5. The machine of claim 3, wherein the application device further comprises an adjustable applicator roll for applying the coating to the cans, and wherein the applicator roll receives the coating from the distribution roll.

6. The machine of claim 3, wherein the metering roll has a chrome outer surface, and the distribution roll has a rubber outer surface.

7. The machine of claim 1, wherein the excess coating removal device comprises a blade contacting the applicator roll to remove excess coating after the applicator roll has applied the coating to the can.

8. The machine of claim 1, further comprising a drip pan for catching excess coating, the drip pan being mounted below the excess coating removal device.

9. The machine of claim 8, further comprising a coating supply tank in fluid communication with the drip pan.

10. A method for coating a selected portion of a beverage or beer can, while preventing excess coating from dripping onto a conveyor or portions of the can not desired to be coated, comprising the steps of:
using an application device to apply the coating to the selected portion of the can;
providing a conveyor to move the cans in a controlled fashion adjacent to the application device; and
providing an excess coating removal device located adjacent the application device, to substantially remove excess coating not needed to coat the selected portion of the can, while substantially preventing the coating from contacting other portions of the can or the conveyor.

11. The method of claim 10, wherein the step of applying the coating comprises mounting an adjustable metering roll a predetermined distance from a stationary distribution roll to form an adjustable gap, so that the amount of coating applied is controlled by the gap.

12. The method of claim 10, wherein the cans comprise beer or beverage cans, and the selected portion of the can comprises a bottom rim of the can.

13. The method of claim 10, wherein the excess coating removal device comprises a blade wiping against the applicator roll to remove excess coating not needed to coat the selected portion of the cans.

14. The method of claim 10, further comprising the step of catching excess coating from the excess coating removal device using a drip pan mounted below the excess coating removal device.

15. The method of claim 14, further comprising the step of providing the drip pan in fluid communication with a coating supply tank.

16. An excess coating removal device for use with a machine for coating a selected portion of a can, while preventing excess coating from dripping onto a conveyor or portions of the can not desired to be coated, wherein the machine includes an applicator roll for applying the coating to the can, and a conveyor for moving cans in a controlled fashion adjacent to the application device, the excess coating removal device comprising:
a blade wiping against the applicator roll to substantially remove excess coating not needed to coat the selected portion of the can, thereby substantially preventing the coating from contacting portions of the can not desired to be coated, or from contacting the conveyor.

17. The excess coating removal device of claim 16, wherein the machine is designed and configured to coat the bottom rim of beer and beverage cans.

18. The excess coating removal device of claim 16, further comprising an adjustable metering roll and a stationary distribution roll, and wherein the metering and distribution rolls are mounted a predetermined distance from each other, forming an adjustable, predetermined gap, and wherein the amount of coating applied to the selected portion of the cans is controlled by the gap.

19. The excess coating removal device of claim 18, wherein the applicator roll of the machine receives the coating from the distribution roll.

20. The excess coating removal device of claim 16, wherein the blade comprises a rubber material that is substantially chemically impervious to the coating.
